(19) United States
(12) Patent Application Publication
(10) Pub. No.: US 2002/0021814 A1
(43) Pub. Date: Feb. 21, 2002

(54) Process for communication and hearing aid system

(76) Inventor: Hans-Ueli Roeck, Hombrechtikon (CH)

Correspondence Address: PEARNE & GORDON LLP, 526 SUPERIOR AVENUE EAST, SUITE 1200, CLEVELAND, OH, 44114-1484, US

(21) Appl. No.: 09/767,444

(22) Filed: Jan. 23, 2001

(51) Int. Cl. H04R 25/00

(52) U.S. Cl. 381/312; 381/316; 381/317; 381/320

(57) ABSTRACT

Time-limited electrical audio signals are fed to an electromechanical output transducer in addition to the signals from the hearing aid input. Some of the time-limited audio signals are user-defined. The process is implemented in a hearing aid having an electromechanical transducer and a signal processor. An audio signal generator has a user-changeable memory and/or a read/write memory that can be programmed by the user.

Process for Communication and Hearing Aid System

This invention concerns the process for communication in the preamble to claim 1 and the hearing aid system in the preamble to claim 7. These types of processes and hearing-aid systems are known. Thus, for example, it is known how to acknowledge manual input on a therapeutic hearing aid, especially an outside hearing aid, as for example with toggle switches, by means of synthesized beep signals, which are fed to the electromechanical output transducer of the hearing aid as electrical audio signals.

Today's therapeutic hearing aids mark the individual who must have such help with a certain stigma of disability, which is felt by young people in particular. So recently, people have tried to design hearing aids indicated for medical reasons aesthetically so they radiate a certain youthfulness or joy, and people do not necessarily have a tendency to hide their handicap by hiding and concealing the device. As part of this increased attractiveness, the goal of this invention is to make communication between the hearing aid and an individual more attractive and more fun.

This is done by the features in claim 1, so at least some of the time-limited audio signals are user-defined. Thus, now it is possible for each user--whether he/she is a user of a therapeutic hearing aid or a hearing aid from entertainment technology, like a headset, for example, with the required characteristics-to be able to choose the audio signals with which events are displayed or acknowledged on the hearing aid himself or herself.

In one preferred embodiment of the process in the invention, the time-limited electric audio signals are produced especially as acknowledgment signals to control signals, which control signals are produced for example manually or by remote control on the hearing aid or are triggered by the hearing aid itself, as for example when the battery voltage drops.

In one preferred embodiment of the process in the invention, at least some of the time-limited audio signals mentioned are stored on memory elements for the hearing aid that can be changed by the user, preferably on storage elements that are read only.

With it, the user can change the storage elements for stored audio signals according to his/her taste. These types of memory elements can be provided as read-only memory by the hearing aid manufacturer in a wide range of different audio signal patterns.

In another preferred embodiment that, if necessary, supplements the last embodiment mentioned, the time-limited audio signals mentioned are user-defined and filed in a storage unit that can itself be built into the hearing aid or is connected to it, preferably wirelessly, or can be brought into working contact with it. In this embodiment, the audio signals mentioned are stored selectively and defined by the user in his/her own hearing aid and can be changed accordingly.

In a third embodiment, which can be combined if necessary with the previously mentioned embodiments, the only information filed in the actual hearing aid is the location where the audio signal sequences to be called up are on a predetermined audio signal carrier. This procedure requires that the user of the hearing aid carry an audio player on him/her, like for example a minidisk player, an MP3 player, etc. Communication between the hearing aid, on one hand, and such a player, on the other, is preferably wireless.

Another preferred embodiment of the process in the invention, in which the output transducer mentioned is a loudspeaker, proposes that at least some of the time-limited electrical audio signals mentioned be produced so that the results of their acoustic transducer can be heard by an individual at a distance as well. Thus, it is possible to transmit information to a user by corresponding acoustic signals even when the hearing aid is not being worn. This can be the case, for example, when the battery voltage drops or when the hearing aid is stored improperly but can be detected, etc.

In another preferred embodiment, the user-defined selection of time-limited electrical audio signals is menu-driven. For this, a communications unit is provided that preferably has a wireless working connection to the hearing aid and leads the user through the selection menu with a visual display and/or by voice.

If the communication unit mentioned is also designed at least for voice control, it is also proposed that the voice control be created via the hearing aid mentioned by storing the corresponding voice signals in the hearing aid.

To solve the problem mentioned at the start, the hearing aid in the invention is characterized by the features in claim 7, and preferred variations are listed in claims 8 to 13.

The invention will be described next with examples using the figures.

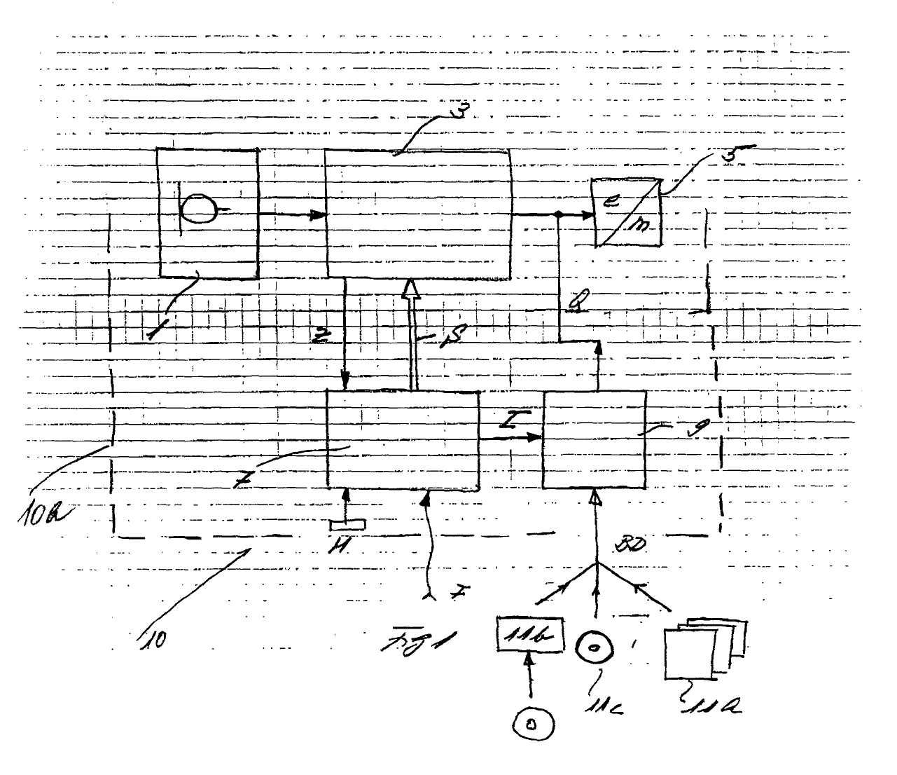

FIG. 1 shows the principle behind the process in the invention and the hearing aid in the invention using a simplified signal flow/function block diagram;

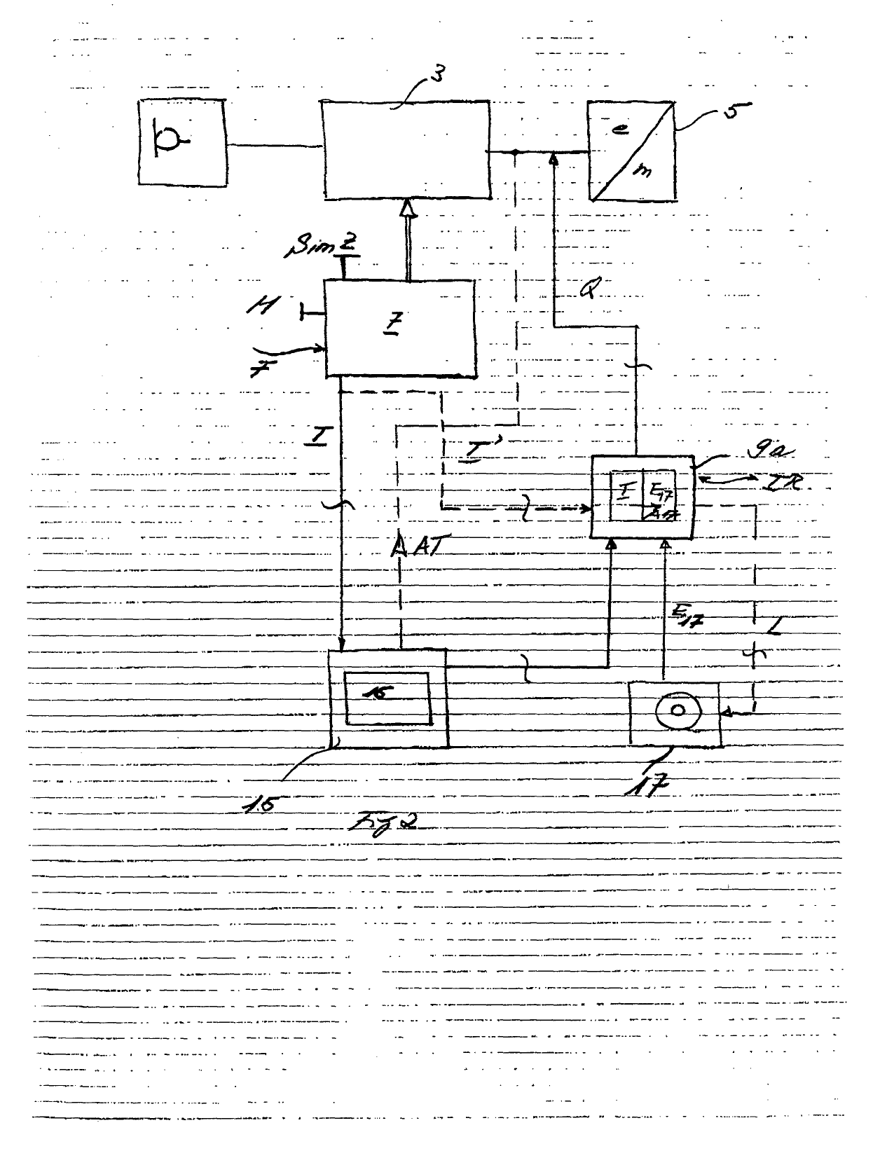

FIG. 2 shows a view similar to the one in FIG. 1 of preferred embodiments of the process and hearing aid system in the invention and;

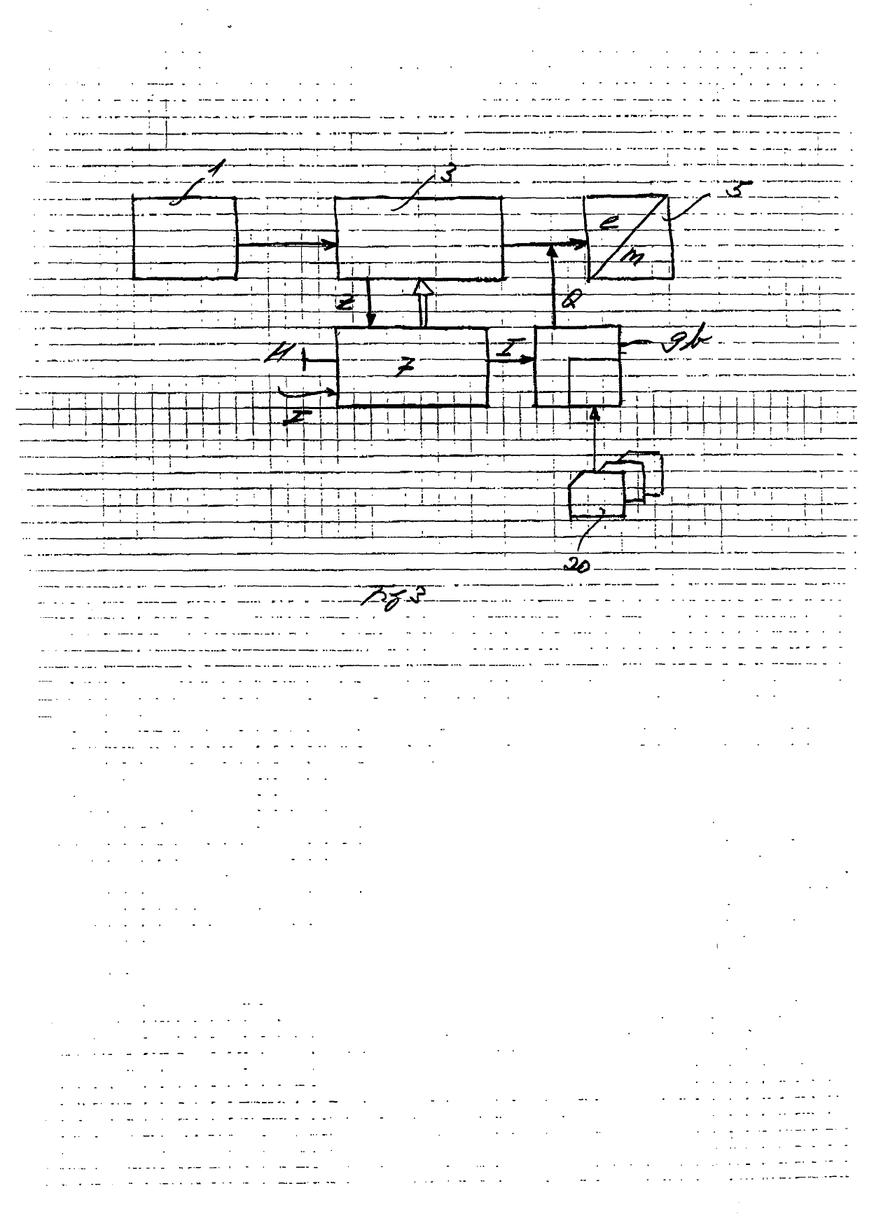

FIG. 3 in turn shows a view like the one in FIGS. 1 and 2 of another preferred variation of the process and the hearing aid system in the invention.

FIG. 1 shows the principle behind this invention using a block diagram of the signal flow/function. A hearing aid system 10 includes a hearing aid in itself, with an acoustic/electric input transducer unit 1 and its usually digital signal-processing unit 3 connected after it, which works on an electrical/mechanical transducer unit 5 at the output. This is an at least partly implanted therapeutic hearing aid 5, so the electrical/mechanical transducer unit 5 is a unit that works mechanically on an ossicle in the middle ear, while on a regular therapeutic in-the-ear or out-of-the-ear hearing aid, the transducer unit mentioned is composed of a loudspeaker unit. Besides being a device for therapeutic purposes, the hearing aid can also be a device not used for therapeutic purposes, like for example a headset.

The signal-processing unit 3 of the actual hearing aid receives control signals S of all kinds, like for example program-switching signals, signals to adjust the volume transmitted, hence basically signals that trigger the signal-processing changes desired by the respective individual when the hearing aid is used. As shown schematically in FIG. 1, these types of signals S are input manually, M, like for example those triggered by pressing switches, or if remote control is provided, are usually wireless, as shown at F. FIG. 1 is a schematic view of the conversion of manually input signals M or signals F transmitted wirelessly into control signals for the signal-processing unit 3 on a coder/decoder unit 7. To this extent, the measures taken on hearing aids, especially therapeutic ones, are known thus far.

It is also known that, as a function of the signals input, as mentioned, manually -M- or by remote control -F- on the hearing aid 10a, acoustic acknowledgment signals that can be perceived by the individual are produced, in the form of characterizing sequences of beep signals. As a function of the control signals input manually M or by remote control F, the coder unit 7 calls up the acknowledgment signals Q assigned to the control signals M, F on a generator unit 9 and feeds them to the electromechanical transducer unit 5 on the input side and converts them into corresponding signals that can be heard by the individual. Thus, the actual hearing aid 10a is always made up of units 1, 3, 5, 7 and 9 and their signal connections, as shown in FIG. 1.

The generator unit 9 provided in these types of known hearing aids is designed as an actual read-only unit, where the acknowledgment signals fed to the transducer unit 5 are stored. Basically, the invention now proposes that on the generator unit 9, in the sense of a read-only storage, the acknowledgment signals Q mentioned no longer be prestored at the factory and fixed, but that these signals can be stored and user-defined. The acknowledgment signals Q assigned to the control signals M, F can be freely selected by the individual using the respective hearing aid and changed in any way he/she likes. Here, the audible user-defined signals that correspond to the electrical acknowledgment signals Q can be voice sequences, music sequences, noises for example,. The system in the invention can now be designed so that:

if necessary, the respective user-defined acknowledgment signals can be called up in time, practically online, directly from a tape recorder, preferably by wireless transmission and converted on the generator unit 9 into the electrical acknowledgment signals Q specifically needed by the device,

the acknowledgment sequences the user wants are selected in advance and are preferably stored directly in the hearing aid;

storage is offered, for example, by the hearing aid manufacturer, on chips for example, and sequences matched to the signals M and F being acknowledged depend on taste and are prestored.

Provision is made so the user-defined signal sequences desired can be stored in the hearing aid or these types of signals can be defined on audio carriers, so this is preferably menu-driven, as will still be explained.

FIG. 1 show the basic approach the invention takes through the signal input BD to the generator unit 9, whereby the user-defined acknowledgment signals Q mentioned are input, whether by user-defined entry of predefined data-storage 11a, or by storage of user-defined stored sequences 11, or by user-defined storage of audio carriers 11c.

As can also be seen from FIG. 1, it is completely possible for statuses like a drop in battery voltage under predetermined values to be signaled to the user by the signal-processing unit 3. Then, the input is to the coder unit 7 by the signal-processing unit 3, as shown by Z. As already explained, a corresponding user-defined acknowledgment signal Q is then also transmitted to the transducer unit 5 and the appearance of the signal Z is displayed to the user with a corresponding user-defined signal.

If necessary, the acknowledgment signal Q can be designed in such a way that on hearing aids with loudspeakers outside, the corresponding audio signals are audible, even if the hearing aid is not even being worn. For example, status-reporting signals Z, which display for example the battery status or how that the hearing aid is being stored in an area where the temperature is too high, etc. can be used by the signal-processing unit 3 to call up a corresponding acknowledgment signal Q, which also gets the user's attention when the hearing aid is stored away from him/her, and leads to the corresponding action. FIG. 2, which is a schematic view, in simplified form, of a block diagram of the signal flow/function of a preferred hearing aid system according to the invention that works by the process in the invention, should explain how a user selects user-defined menu-driven audio sequences and, if necessary also stores them.

In the selection mode for the acknowledgment sequences, the signals I identifying the signal input-manual M- or wireless F- already shown in FIG. 1, of an external display unit 15 with display 16 or with synthetic speech output (not shown), thus for example a laptop, a computer or a remote-control unit are fed to the coder unit 7 on the output side. When the respective identification signal I comes by manual input M or remote input F, the following text is displayed or spoken on the unit 15, for example:

“Please select the acknowledgment signal you want for the program circuit NORMAL ENVIRONMENT/CONCERT HALL. Its maximum permitted length is 5 seconds.”

If the menu-driven text is spoken, then it is displayed, whether a hearing aid or a therapeutic hearing aid is used, to feed it [the text] to the transducer as shown in dashes in FIG. 2 at AT.

The user then turns on any audio signal source, like for example a tape recorder 17 or an Internet page, and in the predetermined length of time, for example 5 seconds, the sequence chosen by the user at the source, is fed to the generator unit 9a in the form of electrical signals E₁₇ and filed there assigned to the specific identification signal I. For this, the identification signal I is looped on the display unit 15 mentioned via the generator unit 9. In the generator unit 9a, in this design, the signal E₁₇ corresponding to the audio sequence selected, is preferably, but not necessarily stored in digital form.

That way, the audio sequences selected by the user for those signals input manually or by remote control, corresponding to M or F, for which user-defined acknowledgment signals Q are desired are stored with the assigned signals I triggering them in the generator unit 9. When the hearing aid is operating, the display unit 15, if it is not a unit built-into a remote-control system, is removed, and as shown at I′, the working connection is set up between the coder unit 7 and the generator unit 9.

But, if necessary, it can also be provided that the audio sequence selected, corresponding to E₁₇, is not stored in the generator unit 9 at all, but that only the data found A₁₇ for the respective sequence are recorded there on a tape recorder, assigned to the respective signal I. In this case, in operation, with the playback device with the tape recorder 17 worn on the individual, when an identification signal I appears, the generator unit 9, as shown in dashes at L, will control the playback unit for playing the audio sequences defined in the generator unit 9. Only then will the signal E₁₇ be fed by the generator unit 9 or if necessary directly to the transducer unit 5.

The signal paths marked by “˜” in FIG. 2 can be based on wireless transmission. Thus, in the selection mode, the signal I can be transmitted wirelessly to the display unit 16, for example as an infrared signal or as a radio signal over a short distance. Likewise, the generator unit 9a can be made separately from the actual hearing aid 1, 3, 5, 7. The acknowledgment signal Q is then transmitted from the generator unit 9a wirelessly to the input of the transducer unit 5. Likewise, from the output of the coder unit 7, the respective signal I calling up an audio sequence is preferably transmitted wirelessly to the generator unit 9. Of course, in this case, transmitting and receiving units must be provided, according to wireless transmission techniques selected, on units 7, 9a, 15, 17 on the input side of the transducer unit 5 (not shown). As already explained using FIG. 1, should statuses recorded by the specific hearing aid 1, 3, 5 trigger acknowledgment signals Q corresponding to signals Z, on the selection menu for the corresponding audio sequences, the signals Z that can occur, should be simulated and, as was described, assigned to the respective audio sequences. Such simulation can be triggered, for example, by pressing a key on the hearing aid, as shown by SimZ in FIG. 2.

Even when only found data A₁₇ assigned to signals I are stored in the generator unit 9, which then call up audio sequences defined by a tape recorder 17 practically online, on the generator unit 9a, in the sense of a read/write memory, there is RAM data storage in a corresponding memory, and the found data mentioned can be changed at any time by the user, to assign other audio sequences to the respective control signals I as acknowledgment signals Q.

FIG. 3 shows another preferred embodiment of the hearing aid in the invention, which is fully integrated. The generator unit 9b here is part of the actual hearing aid, for which the desired acknowledgment signal/audio sequences and their user-changeable storage, like chips 20, for example, are chosen. Preferably, a selection of different acknowledgment signals is made available in memories 20, by means of which the user can select the style or sound structure he/she likes. By changing the memory 20, which is then desired preferably as a read-only memory ROM, the user selects which acknowledgment signals he wants to hear for the assigned switching signals M, F or Z.

With this invention, it will be possible for the user of both therapeutic hearing aids and also hearing aids from the entertainment industry, for example headsets, to stop using dry, technical acknowledgment signals like the known beep signals and to choose his/her personal acknowledgment signals. It is possible, with the process in FIG. 3 for example, for young people to exchange memories between them, or a preferably wireless interface is created between the generator units 9a of different hearing aid systems with the design in FIG. 2, as by infrared, to synchronize a generator unit 5 with the audio sequences of another hearing aid system, as shown in FIG. 2 by Iₓ.

1. A process for communication between a hearing aid and an individual, in which time-limited electrical audio signals (Q) are fed to an electromechanical output transducer (5) of the hearing aid in addition to signals that are acoustic or electric audio signals fed by the hearing aid on the input side (1), characterized by the fact that at least some of the time-limited audio signals (Q) are user-defined.

2. The process in claim 1, characterized by the fact that the time-limited electric audio signals are produced as acknowledgment signals on control signals (M, F, Z) on or to the hearing aid.

3. The process in one of claims 1 or 2, characterized by the fact that at least some of the time-limited audio signals (Q)
are stored on user-changeable memory elements (20) for the hearing aid, preferably read-only, and/or
are filed user-defined in a memory unit (9a, 11b), which is built into the hearing aid (9a) and has or can be brought into a working, preferably wireless connection with it, and/or
user-defined location information in the hearing aid for the audio signals mentioned is filed on an audio signal carrier and the audio signals can be called up selectively from the carrier via that information.

4. The process in one of claims 1 to 3, characterized by the fact that the electromechanical output transducer is a loudspeaker and at least some of the time-limited electric audio signals (Q) are produced so that the results of the conversion are audible by an individual at a distance.

5. The process in one of claims 1 to 4, characterized by the fact that the user definition of the time-limited electric audio signals is menu-driven, preferably by a communications unit (15) that can be connected to the hearing aid and is preferably wireless.

6. The process in claim 5, characterized by the fact that the communications unit controls the menu via a visual display and/or voice control, preferably by feeding voice signals into the hearing aid.

7. A hearing aid system with at least one hearing aid, which contains:
a signal-processing unit (3) which is connected on the output side to
an electromechanical transducer with a working connection,
an audio signal generator unit, whose output also has a working connection to the input of the electromechanical transducer (5),
characterized by the fact that the audio signal generator unit (9, 9a, 9b) has a user-changeable memory (20, 11a) and/or a read/write memory (9a) that can be written on by the user.

8. The system in claim 7, characterized by the fact that the audio signal generator unit (9, 9a, 9b) has an addressing input (I) for the memory (20, 9a), which has a working connection with control signalproducing organs (7, 3) in the hearing aid.

9. The system in claim 8, characterized by the fact that the production unit includes manually activated switching organs (M) on the hearing aid and/or organs having a working connection to a remotecontrol input of the hearing aid and/or the signal-processing unit (3).

10. The system in one of claims 7 to 9, characterized by the fact that the read/write memory is designed for user-defined storage of audio-signal sequences of a predetermined length or the fact that the write input of the read/write memory can or does have a working connection to or has a working connection to an audio signal source.

11. The system in claim 10, characterized by the fact that the audio source I is an audio player or a unit with an Internet connection.

12. The system in one of claims 7 to 11, characterized by the fact that it includes a display unit for visual and/or voice-controlled menu control, which has or can have a working connection to the control-signal-producing organs of the hearing aid, on one hand, and to the audio-signal generator unit on the other.

13. The system in claim 12, characterized by the fact that the display unit is designed for voice control by menus and has a working connection on the output side with the input of the electromechanical transducer of the hearing aid.
